(19) United States
(12) Patent Application Publication
(10) Pub. No.: US 2019/0254283 A1
(43) Pub. Date: Aug. 22, 2019

(54) INSECT REPELLENT COMPOSITIONS AND MATERIALS BEARING THE SAME

(71) Applicant: Tanveer Daswani, Mumbai (IN)

(72) Inventor: Tanveer Daswani, Mumbai (IN)

(21) Appl. No.: 16/035,580

(22) Filed: Jul. 13, 2018

(30) Foreign Application Priority Data
Feb. 17, 2018 (IN) 201821006121

(51) Int. Cl. A01N 53/00; A01N 65/18; D06M 13/224

(52) U.S. Cl. CPC A01N 53/00; A01N 65/18; A01N 25/02; A01N 2300/00; D06M 13/2246

(57) ABSTRACT

Insect repellent compositions are provided for resilient use in fabrics. Compositions include an alcohol solvent and an ethoxylated oil mixed with an insecticidal pyrethroid of at least 25% of the composition. Permethrin, benzyl alcohol, and ethoxylated castor oil may be used in ratios ranging from about 2.5:1.5:1 to about 1:1.2:1.8. An insect repellent fabric is prepared by neutralizing the fabric and treating the fabric with the insect repellent formulation. The formulation may include a padding composition mixed with an insect repellent composition. The padding composition includes a polyglycol ether, an acrylic acid ester, an acrylic ester copolymer in aqueous solution, and a cross linking agent. The fabric may be evenly treated with the mixed padding and repellent composition and then dried. The treating may include impregnating the fabric with microcapsules that elute or diffuse the insect repellent and/or padding composition.

### RELATED APPLICATIONS

This application claims priority under 35 U.S.C. § 119 to co-pending US Indian Application 201821006121, filed Feb. 17, 2018 and incorporated by reference herein in its entirety.

### BACKGROUND

Insect repellents contain active ingredients in various forms. For example, creams use N,N-Diethyl-meta-toluamide, or DEET, as a common active ingredient for insect repellents to be applied to the skin. However, manufacturers advise that DEET products should not be used under clothing or on damaged skin and that the preparations should be washed off after they are no longer needed or between applications, as DEET can act as an irritant. Or, for example, sprays have been used as carriers for insect repellent. However, chlorofluorocarbons present in some sprays are of worldwide concern as they affect the ozone layer of the atmosphere. Typically, sprays require rooms to be kept sealed or closed for some time, such as 15 minutes, to be effective in killing as many insects as possible. Sprays typically have a short residual effect. Once the aerosol has settled out of the atmosphere insects, can again enter the area without effect. Active ingredients, such as (+)-allethrin or (+)-trans-allethrin, are rapidly degraded by light.

Pyrethroids, both the naturally occurring compounds and their synthetically prepared analogues, have been used as active ingredients to effectively control a variety of pests such as houseflies, mosquitoes, cockroaches, etc. Pyrethroids are generally not harmful to plants, foods, animals and humans and leave no harmful residues. First generation pyrethroids such as allethrins are generally simple variations of chrysanthemic acid developed by the 1960s; as mentioned above, they are sensitive to sunlight, air, and temperature and readily break down in the same. By the 1970s, second and later generation pyrethroids were developed with better stability and resiliency to environmental exposure, including cypermethrin and fenvalerate. For example, permethrin is a second-generation broad-spectrum insecticide useful against a variety of pests on nut, fruit, vegetable, cotton, ornamental, mushroom, potato, and cereal crops. It is one of the most widely used pyrethroids with a long history of usage. It is environmentally safe and has been found to be compatible with most fabric substrates, without adversely affecting the desired properties of the fabric. It is a synthetic pyrethroid which exhibits repellent as well as knockdown and kill activity against insects. It has been applied on fabric to help combat mosquitoes, ticks, fleas, bedbugs, chiggers, and flies.

Even some second generation pyrethroids still break down with modest environmental exposure. For example, permethrin has only limited general utility because of its relatively short-lived insecticidal activity, due to its decomposition into an inactive, non-insecticidal product in the presence of oxygen and ultraviolet light. The speed of this decomposition is dependent upon the environment in which it is placed, but typically takes place in several hours to several days or weeks. Pyrethroids may be stabilized by the addition of antioxidants and photostable ultraviolet-light-absorbent compounds to solutions of pyrethroids or even binders to stabilize the deposition of permethrin to various fabric substances. Microencapsulation using porous microcapsules may be used to stabilize pyrethroids and yet release their content when required.

U.S. Pat. No. 5,089,298 issued Feb. 2, 1992 to McNalley et al. and incorporated herein by reference in its entirety, discloses a synergism between an amylopectin, a water soluble form of starch, and permethrin combination on textile fabrics to afford greater retention of permethrin in clothing through repeated wash cycles as compared to garments treated only with permethrin. U.S. Pat. No. 5,503,918 issued Mar. 10, 1995 to Damson et al. and incorporated herein in its entirety by reference, describes using polyvinyl acetate as a binder for the permethrin dispersion to preserve the effectiveness of the permethrin through more washings of the fabric than amylopectin. U.S. Pat. No. 5,631,072 issued Mar. 10, 1995 to Samson et al. and incorporated herein by reference in its entirety, discloses wash-durable permethrin-treated garments prepared from a fabric that is either impregnated or single-side surface-coated with a dispersion of permethrin. In the case of impregnation, a dispersion of permethrin, a polymeric binder such as acrylic copolymer or polyvinyl acetate, and optionally a cross-linking agent such as methylated melamine resin is used. In the single-side surface coating embodiment, the fabric is treated with the insecticide and a thickener such as carboxymethyl cellulose and optionally a polymeric binder that is optionally cross-linked.

U.S. Pat. No. 4,765,982 issued Apr. 30, 1982 to Ronning et al. and incorporated herein in its entirety, discloses controlled release insect control devices like webs, tapes, sheets, pads, etc. based on micro-encapsulated pyrethroid insecticide that self-adheres to rough-surfaced fibers comprised of graft polymers of cellulose and an ethylenically unsaturated material co-polymerizable therewith. U.S. Pat. No. 4,056,610 issued Apr. 9, 1975 to Barber, Jr. et al. and incorporated herein by reference in its entirety discloses a microcapsule insecticide composition in which a pyrethroid permeates a porous shell wall and maintains an effective level of the pyrethroid upon the outer surface of the shell wall to control insects for up to four days. Control is achieved by killing insects contacting the pyrethroid released though the capsule wall.

### SUMMARY

Example embodiments include insect repellent compositions with long-lasting efficacy in fabrics, even after long periods of time and many wash cycles. Example compositions include an alcohol solvent, an ethoxylated oil, and an insecticidal pyrethroid mixed therein in an amount of at least 25% by weight of the composition. A more resilient pyrethroid, such as a second generation or later pyrethroid like permethrin known for its long-standing safety record, may be used for up to about half of the composition by weight. The balance of the composition may be the alcohol solvent, such as an aromatic alcohol like benzyl alcohol, the ethoxylated oil, such as castor oil with large amounts of ricinoleic acid that is ethoxylated, and other synergistic ingredients and unavoidable impurities. For example, the alcohol solvent may be about 15% to about 45% by weight of the composition, and the ethoxylated oil may be about 25% to about 50% by weight of the composition.

Example methods include preparing an insect repellent fabric by neutralizing the fabric and treating the fabric with the insect repellent formulation having a padding composition mixed with an insect repellent composition, like an example embodiment insect repellent composition with an alcohol solvent, an ethoxylated oil, and an insecticidal pyrethroid. Neutralizing may be performed with an aqueous acid and buffer like citric acid, and the fabric may be dried after its application. The padding composition into which the insect repellent composition is mixed may include a polyglycol ether, an acrylic acid ester, an acrylic ester copolymer in aqueous solution, and a cross linking agent. Physically, the fabric may be run at a constant speed or otherwise evenly treated with the mixed padding and repellent composition and then dried at about 100 degrees Celsius and cured at about 150 degrees Celsius for at least 1 minute. The treating may include impregnating the fabric with microcapsules bearing the insect repellent and/or padding composition.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of an example embodiment fabric bearing insect repellent compositions.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

It will be understood that, although the terms first, second, etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods. As used herein, the term “and/or” includes all combinations of one or more of the associated listed items. The use of “etc.” is defined as “et cetera” and indicates the inclusion of all other elements belonging to the same group of the preceding items, in any “and/or” combination(s).

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, the singular forms “a,” “an,” and “the” are intended to include both the singular and plural forms, unless the language explicitly indicates otherwise. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof. The use of “about” in connection with values indicates effective approximation, and such values may vary within a range having substantially similar activity or functionality. As such, values referred to as “about” include similar values and precisions expected with applicable manufacturing tolerances and unavoidable impurities in the element of the value, and generally would be expected to vary less than 15% of the value itself.

The structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from single operations described below. It should be presumed that any embodiment or method having features and functionality described below, in any workable combination, falls within the scope of example embodiments.

The Inventor has recognized that there is a need for fabric treated with a resilient insect repellent chemical, not as merely a spray or cream. However, a repellent like a pyrethroid must have durability and efficiency for an extended period in the fabric. Permethrin specifically as an insect repellent in treated fabrics has poor wash durability, and there is a need for retention of permethrin in garments and wares made from treated fabric, despite repeated wash cycles of machine laundering or hand washes. Thus, the inventor has recognized both a need for an application of a pyrethroid like permethrin in fabrics and, further, a need for wash durability and extended efficiency of the repellent in the fabric. The Inventor has developed example embodiments and methods described below to address these and other problems recognized by the Inventor with unique solutions enabled by example embodiments.

The present invention is wash-resilient pyrethroid insect repellent compositions for use in fabrics, methods of creating such compositions and fabrics, and such fabrics. In contrast to the present invention, the few example embodiments and example methods discussed below illustrate just a subset of the variety of different configurations that can be used as and/or in connection with the present invention.

Example embodiments include an insect repellent composition, by weight, of a pyrethroid, such as permethrin, in an amount of about 25 to 50%; an ethoxylated oil, such as castor oil, in an amount of about 25 to 50%; and a solvent like benzyl alcohol in an amount of about 15 to 45%. For example, a ratio of permethrin to ethoxylated castor oil to benzyl alcohol may be 2.5:1.5:1 by weights, or 1:1.2:1.8 by weights. Supplementation with other carrier and inactive ingredients may be used, and other additives and impurities, such as color or scent additions for commercial acceptability and unavoidable industrial contamination may be present that do not interfere with insect repellent efficacy.

The following tables illustrate just a few different combinations of ingredients that may make up example embodiment insect repellents.

TABLE 1
Example Insect Repellent Composition

| Ingredient | Amount |
|---|---|
| Permethrin (cis:trans 25:75) w/w | 50 |
| Ethoxylated Castor Oil w/w | 30 |
| Benzyl alcohol w/w | 20 |

TABLE 2
Example Insect Repellent Composition

| Ingredient | Amount |
|---|---|
| Permethrin (cis:trans 25:75) w/w | 25 |
| Ethoxylated Castor Oil w/w | 30 |
| Benzyl alcohol w/w | 45 |

TABLE 3
Example Insect Repellent Composition

| Ingredient | Amount |
|---|---|
| Permethrin (cis:trans 25:75) w/w | 40 |
| Ethoxylated Castor Oil w/w | 40 |
| Benzyl alcohol w/w | 20 |

Example embodiment compositions may be formulated through example methods including adding together a homogeneous solution of benzyl alcohol and permethrin with permethrin in proportion to benzyl alcohol with constant stirring at a controlled temperature of about 50° C. Ethoxylated castor oil may then be added with constant stirring at a controlled temperature of 50° C. to obtain a homogenous composition. The composition may then be cooled and used as an insect repellent. For example, benzyl alcohol may be stirred in a reaction vessel while adding permethrin in portions and mixed at around 50° C. to form a homogeneous mixture. Hydrogenated castor oil may be added to the mixture with stirring to make homogenous the example embodiment insect repellent composition.

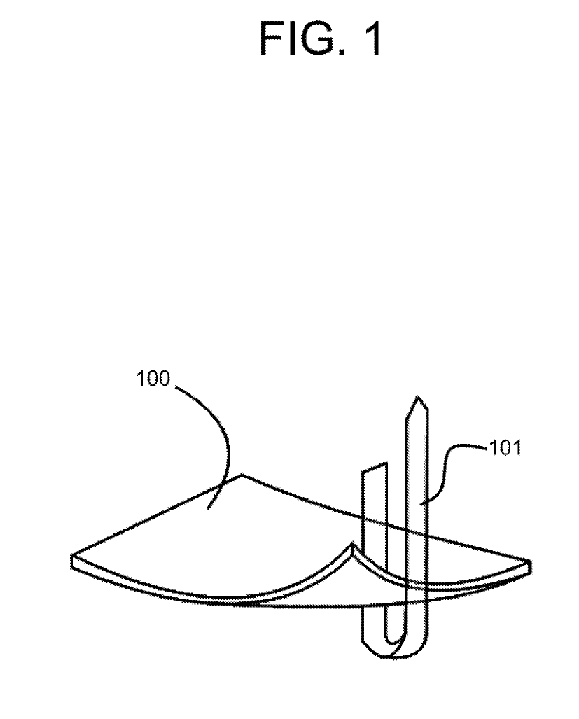

Example embodiment insect repellent compositions, when applied to fabric, have a wash durability of at least 25 washes and up to 100 washes while retaining efficacy. FIG. 1 is an illustration of an example embodiment fabric 100 carrying an example embodiment insect repellent 101, and fabric 100 is useable in any fabric application, including clothing, netting, bedding, upholstery, shading, screening, decor, cleaning, etc.

Example methods of creating fabrics bearing example embodiment insect repellents include neutralizing the fabric, such as with citric acid; drying the fabric; combining polyglycol ether, acrylic acid ester, acrylic ester copolymer in aqueous solution, and a cross linking agent to form a carrier or padding composition; preparing an insect repellent composition of permethrin in an amount by weight of about 25 to 50% emulsified concentrate, ethoxylated castor oil in an amount of about 25 to 50%, and benzyl alcohol in an amount of about 15 to 45%; adding the padding composition to the insect repellent composition to make an insect repellent formulation; and treating the fabric with the insect repellent formulation. Treating the fabric with the insect repellent formulation may include running the fabric through the padding solution at a constant speed; drying the fabric at about 100 degree Celsius; and curing the fabric at about 150 degree Celsius for a dwell time of 1 minute. Additionally or alternatively, the fabric may be impregnated with the padding composition by dipping, padding, an exhaust process, coating, spraying, and/or applying.

A padding solution may be formulated in an example method including separating non-ionic alcohol polyglycol ether liquid, acrylic acid ester liquid, and non-ionic polyurethane. Each liquid may be diluted with water in 1:1 ratio. Non-diluted non-ionic alcohol polyglycol ether liquid, a wetting & detergent/non-ionic surfactant, may be added, as well as non-diluted acrylic acid ester liquid, an acrylic cross-linking binder and non-diluted non-ionic polyurethane new liquid, a hydrophobic cross-linking agent for soil and water repelling. Citric acid may be added and the pH of the bath adjusted to 4.5. Undiluted 25% -50% Permethrin EC may then be slowly added under constant stirring, and the obtained mixture may be stirred continuously until a homogeneous padding mixture is formed.

Any fabric may be used with example embodiment compositions and methods; however, fabrics aside from pure polypropylene may provide best resilience and results. Treating the fabric with the inset repellent formulation may include impregnating the insect repellent composition by padding or by exhausting at an ambient temperature. For example, a microencapsulation method may be used, where the fabric is impregnated with example embodiment insect repellent microcapsules that lie safely just under the outer surface of the fabric, where they release repellent over time through diffusion and capsule bursting. If active ingredient is not on the surface of the fabric, the fabric and repellent may be longer lasting. For example, millions of microcapsules may be impregnated beneath the fabric surface for desired efficacy.

For example, the fabric can be prepared by pre-washing it to remove any impurities for 30 min at 85° C. and then drained. The fabric may be rinsed and warmed at 80° C. for 20 minutes followed by additional draining. The fabric may be neutralized with acetic acid—1 gpl—for 15 min at 40° C. followed by draining. The fabric may then be rinsed cold followed by draining. The fabric may then be checked for: water absorption occurring at less than 3 seconds; pH between 4.5 and 6; and impurities.

For example, the volume of padding solution to use on the fabric may be calculated from (a·c)+b, where a is the total weight of fabric in kilograms, b is the minimum quantity required in the stenter; and c is the wet pick percentage of the fabric. This volume of padding solution may be used in a bath.

Microcapsules bearing insect repellent may be made by coacervation with polymers. The microcapsules are then impregnated into the fabric using padding/curing as mentioned above to give precisely controlled dosage and deposition in a computer-controlled process. Microcapsules may be immersed into the fabric so that they become a part of the fabric surface itself while simultaneously providing all the benefits of a reservoir containing the active ingredient.

Upon treatment of the fabric with the insect repellent composition, the fabric may further be treated with fabric softeners, thickeners, and/or any other additives, such as foaming agents, resins, binder systems, fluorocarbons, anti-soil products and flame retardants, that do not interfere with wash durability or insecticidal efficacy. In an example method, the treated fabric may then be cured at a temperature in the range of about 100 to 140° C. to finalize the color and fabric. Curing may achieve greater durability and resistance when limited to not interfere with wash durability or insecticidal efficacy.

For example, the fabric may be padded, dried, and cured by thoroughly cleaning a tough, setting a pressure of the mandle to achieve a percent wet pick equal to c used in calculating the padding volume, and setting the stenter temperature to 100° C. with remaining chambers set to 120° C. The fabric may then be run through the padding solution at constant speed and cured with a stenter temperature of 150° C. with a dwell time of 1 minute.

Fabrics treated with example embodiment insect repellents and methods have been found to have significantly improved activity against mosquitoes. In one test, fabric was cut into pieces of about 25×25 cm size and spread on thermocol board. Two WHO cones were fixed on the fabric/piece. Non-blood-fed susceptible female mosquitoes aged 3-5 days were introduced into the WHO cones and exposed to the fabric for a period of 3 minutes. Five replicates of 10 mosquitoes each were used for the fresh fabric samples, and 5 mosquitoes/replicate were used for control and fabric samples after 30 washes per ISO 6330 standards. After 3 minutes exposure, mosquitoes were collected using an aspirator and placed, 10 individuals in each 150 ml plastic cup with 10% sucrose solution as feed and maintained at a temperature of 27±20° C. and 80±10% relative humidity. Observation on knockdown immediately after exposure and after 60 minutes were recorded. Mortality after 24 hours was determined and recorded. Table 4 below summarizes the results.

TABLE 4
Cone Bioassay against Aedes Aegypti

| Effect | Fresh | After 30 Washes | Control |
|---|---|---|---|
| Knockdown at 3 minutes | 0% | 0% | 0% |
| Knockdown at 60 minutes | 100% | 100% | 9% |
| Mortality at 24 hrs | 98% | 92% | 8% |

As seen, the treated fabric when fresh exhibited knockdown of 100% at one hour and 98% mortality at 24 hours after exposure. Similarly, the fabric when washed 30 times exhibited 100% knockdown at one hour and 92% morality 24 hours after exposure. This is seen to meet the criteria specified by World Health Organization, “Report of the WHO Informal Consultation,” 28-30 Sep., 1998, Geneva, incorporated herein by reference in its entirety, of over 80% mortality at 24 hours or over 95% knockdown at 1 hour after exposure, maintained up to 30 washes.

In another test, efficacy of three textile samples impregnated with example embodiment compositions were evaluated when fresh and after 30, 50, and 100 washes in standard WHO-Tubes with yellow-fever mosquitoes (Aedes Aegypti). Tests were performed according to a procedure published by Technical Guideline TL 8305-0331 by the German Armed Forces (version December 2014), incorporated herein by reference in its entirety. This specification test bioactivity of permethrin-impregnated textiles that had been laundered 100 times. The test samples were fixed to the inner walls of standard WHO plastic tubes, afterwards 10 test mosquitoes were introduced into the tube and exposed to the treated surface. The time until all test mosquitoes were knocked-down was documented. In addition, the time until the first and fifth test mosquito was knocked-down was also recorded. Positive knockdown was defined as inability to fly and staggering. Each sample was tested in 3 repetitions on a total of 30 test mosquitoes. The general fitness of the test mosquitoes was followed in a tube with 10 mosquitoes that were exposed to an untreated cotton cloth. During these tests, a 100% Ae. aegypti knockdown must be documented within 71.5 minutes.

The fabric impregnated with example embodiment compositions without wash caused 100% knockdown within an average of 17 minutes and 8 seconds. The fabric impregnated with example embodiment compositions with 30 washes yielded 100% knockdown after an average of 19 minutes and 55 seconds. The fabric impregnated with example embodiment compositions with 50 washes yielded 100% knockdown after an average of 17 minutes and 2 seconds. The fabric impregnated with example embodiment compositions with 100 washes yielded 100% knockdown after an average of 26 minutes 42 seconds. The durations until knockdown of the first, fifth, and all test mosquitoes were documented as summarized below in Table 5.

TABLE 5
Exposition Tests with Aedes Aegypti

| | Mean time until | Mean time until | Mean time until 100% |
|---|---|---|---|
| | knock-down of | knock-down of | knock-down of all |
| Sample | 1^{st} test mosquito | 5^{th} test mosquito | mosquitos |
| original | 00:03:25 ± 00:00:13 | 00:10:53 ± 00:00:43 | 00:17:08 ± 00:00:26 |
| 30 Washes | 00:09:02 ± 00:00:24 | 00:15:28 ± 00:00:18 | 00:19:55 ± 00:00:59 |
| 50 Washes | 00:07:07 ± 00:01:12 | 00:11:40 ± 00:00:24 | 00:17:02 ± 00:00:57 |
| 100 Washes | 00:08:04 ± 00:00:18 | 00:13:25 ± 00:00:57 | 00:26:42 ± 00:01:28 |

All samples met the criteria demanded by TL 8305-0331 and caused total knockdown within 1 hour, 11 minutes, 30 seconds (or 71.5 minutes). In tests using example embodiment compositions impregnated in fresh fabric, the first mosquito was knocked-down after an average of 3 minutes, 52 seconds; five mosquitoes were found to be immobilized after an average of 10 minutes, 53 seconds, and total knockdown was observed after an average of 17 minutes, 8 seconds. The washing cycles had no noticeable impact on the overall efficacy. After 30 washes, the first knockdown occurred after an average of 9 minutes, 2 seconds; five mosquitoes were immobilized after an average of 15 minutes, 28 seconds; and total knockdown was documented after an average of 19 minutes, 55 seconds. After 50 washes, the first knockdown occurred after an average of 7 minutes, 7 seconds; five mosquitoes were knocked down after an average of 11 minutes, 40 seconds; and total knockdown was recorded after an average of 17 minutes 2 seconds. After 100 washes, the first knockdown occurred after an average of 8 minutes 4 seconds; five mosquitoes were knocked down after an average of 13 minutes, 25 seconds; and total knockdown was recorded after an average of 26 minutes 42 seconds.

The general fitness of the test mosquitoes was tracked in tubes holding untreated cotton clothes. All control mosquitoes stayed vivid throughout the testing time.

It will be appreciated by one skilled in the art that example embodiments may be varied through routine experimentation and without further inventive activity. For example, although permethrin is used in some example embodiments, it is understood that other resilient pyrethroids can be substituted for it in functionally equivalent amounts. Variations are not to be regarded as departure from the spirit and scope of the exemplary embodiments, and all such modifications as would be obvious to one skilled in the art are intended to be included within the scope of the following claims.

What is claimed is:

1. An insect repellent composition comprising:
permethrin in an amount by weight of about 25% to about 50%;
ethoxylated castor oil in an amount by weight of about 25% to 50%; and
benzyl alcohol in an amount by weight of about 15% to 45%.

2. The composition of claim 1, wherein permethrin, ethoxylated castor oil, benzyl alcohol, and unavoidable impurities are the only ingredients.

3. The composition of claim 1, wherein the ratio by weight of permethrin to ethoxylated castor oil to benzyl alcohol is about 2.5:1.5:1.

4. The composition of claim 1, wherein the ratio by weight of permethrin to ethoxylated castor oil to benzyl alcohol is about 1:1.2:1.8.

5. The insect repellent composition of claim 1, wherein the permethrin is about 50% by weight of the composition.

6. An insect repellent composition comprising:
an alcohol solvent;
an ethoxylated oil; and
an insecticidal pyrethroid emulsified in the ethoxylated oil in an amount of at least 25% by weight of the composition.

7. The composition of claim 6, wherein the insecticidal pyrethroid is a second generation or later pyrethroid resistant to light, air, and temperature breakdown.

8. The composition of claim 7, wherein the insecticidal pyrethroid is permethrin of about 25% to about 50% by weight of the composition.

9. The composition of claim 6, wherein the alcohol solvent is an aromatic alcohol, and wherein the ethoxylated oil is ethoxylated from an oil having over 50% ricinoleic acid.

10. The composition of claim 9, wherein the alcohol solvent is benzyl alcohol in an amount of about 15% to about 45% by weight of the composition, and wherein the ethoxylated oil is ethoxylated castor oil in an amount of about 25% to about 50% by weight of the composition.

11. The composition of claim 10, wherein the insecticidal pyrethroid is permethrin.

12. A method of preparing an insect repellent fabric, the method comprising:
neutralizing the fabric; and
treating the fabric with an insect repellent composition, wherein the insect repellent composition includes,
an alcohol solvent,
an ethoxylated oil, and
an insecticidal pyrethroid emulsified in the ethoxylated oil in an amount of at least 25% by weight of the insect repellent composition.

13. The method of claim 12, wherein the neutralizing is performed with an aqueous acid, the method further comprising:
drying the fabric following the neutralizing.

14. The method of claim 12, further comprising:
treating the fabric with a padding composition, wherein the padding composition includes a polyglycol ether, an acrylic acid ester, an acrylic ester copolymer in aqueous solution, and a cross linking agent.

15. The method of claim 12, wherein the treating includes,
running the fabric evenly through a padding composition and insect repellent composition,
drying the fabric at about 100 degrees Celsius, and
curing the fabric at about 150 degrees Celsius for at least 1 minute.

16. The method of claim 15, wherein the running is performed in about 15 to about 45 minutes at a temperature from about 70 degrees Celsius to about 90 degrees Celsius, and wherein the drying is performed for about 10 minutes to about 30 minutes at a temperature from about 35 degrees Celsius to about 45 degrees Celsius.

17. The method of claim 12, wherein the treating includes impregnating the fabric with the insect repellent formulation by at least one of dipping, padding, an exhaust process, coating, spraying, and applying.

18. The method of claim 12, wherein the alcohol solvent is an aromatic alcohol, the ethoxylated oil is ethoxylated from an oil having at least 50% ricinoleic acid, and the insecticidal pyrethroid is permethrin.

19. The method of claim 18, wherein the permethrin is about 25% to about 50% by weight of the insect repellent composition.

20. The method of claim 19, wherein the alcohol solvent is benzyl alcohol in an amount of about 15% to about 45% by weight of the insect repellent composition, and wherein the ethoxylated oil is ethoxylated castor oil in an amount of about 25% to 50% by weight of the insect repellent composition.
